(19) United States
(12) Patent Application Publication
(10) Pub. No.: US 2008/0088615 A1
(43) Pub. Date: Apr. 17, 2008

(54) Driving method for liquid crystal display using block cycle inversion

(75) Inventors: Sz-Hsiao Chen, Miao-Li (TW); Eddy Giing-Lii Chen, Miao-Li (TW); Tsau-Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/974,125

(22) Filed: Oct. 11, 2007

(30) Foreign Application Priority Data
Oct. 11, 2006 (TW) 95137307

(51) Int. Cl. G09G 5/00

(52) U.S. Cl. 345/209

(57) ABSTRACT

An exemplary method for driving a typical liquid crystal display (2) with a matrix of pixels (205) includes the steps of: (a) applying video signals with a first polarity pattern to the pixels during a frame period, (b) re-defining the first polarity pattern by sequentially shifting the polarity sequences of one row to an adjacent row within a 2K-by-2K square sub-matrix of the pixels; (c) applying video signals with the re-defined first polarity pattern to the matrix of pixels during next frame period; and (d) repeating steps (b) and (c).

### BACKGROUND OF THE INVENTION

1. Field of the Invention

The present invention relates to driving methods for liquid crystal displays, and in particular to a driving method using a block inversion method.

2. General Background

A liquid crystal display utilizes liquid crystal molecules to control light transmissivity of each of pixels. The liquid crystal molecules are driven according to external video signals received by the liquid crystal display. Conventional liquid crystal displays generally employ a selected one of a frame inversion system, a line inversion system, or a dot inversion system to drive the liquid crystal molecules. Each of these driving systems can protect the liquid crystal molecules from decay or damage.

FIG. 8 illustrates a series of polarity patterns of video signals for a liquid crystal panel of a liquid crystal display, using the conventional dot inversion driving method. In order to simplify the following explanation, FIG. 8 only shows a 4-by-4 sub-matrix of pixels of the liquid crystal panel. The polarity of each pixel in FIG. 8 is opposite to the polarity of every adjacent pixel, and the polarity of each pixel is reversed once in every frame period. When a flicker test pattern as shown in FIG. 9 is applied to the liquid crystal panel, the pixels with oblique lines are disabled, and only the pixels marked with “R”, “G”, and “B” are enabled. Referring to FIG. 10, this illustrates a series of polarity patterns with circles, in order to show characteristics of an image flicker test applied to the liquid crystal display using the conventional dot inversion driving method. As shown in FIG. 10, the pixels marked with circles all have a positive polarity during an (n−1)^{th} frame period, a negative polarity during an n^{th} frame period, and a positive polarity again during an (n+1)^{th} frame period. The pixels displaying the same gray level but having opposite polarities may have different charging conditions because the common voltage of the liquid crystal panel may shift slightly when the polarity of each pixel is changed. Simultaneously, flickers occur when the polarities of all the enabled pixels displaying a same gray level are inverted at the same time.

Accordingly, a 2-line inversion driving method has been developed. FIG. 11 illustrates a series of polarity patterns of video signals for a liquid crystal panel using the conventional 2-line inversion driving method. In order to simplify the following explanation, FIG. 11 only shows a 4-by-4 sub-matrix of pixels of the liquid crystal panel. The other pixels of the liquid crystal panel have a polarity arrangement similar to that shown in FIG. 11. The polarities of the pixels in first and second rows are the same. The polarities of the pixels in the third and fourth rows are the same. The polarities of the pixels in the second and third rows are reversed, and the polarities of the pixels in each column are opposite to the polarities of the pixels in each of the two adjacent columns. Moreover, the polarity of each pixel is reversed once in every frame period.

FIG. 12 illustrates a series of polarity patterns with circles, in order to show characteristics of an image flicker test applied to the liquid crystal display using the conventional 2-line inversion driving method. When a flicker test pattern such as that shown in FIG. 9 is applied to the liquid crystal panel using the 2-line inversion method, only the pixels marked with circles are enabled. Each enabled pixel has a positive polarity during one frame period, a negative polarity during the next frame period, a positive polarity again during the next frame period, and so on. This can balance the brightness differences of each enabled pixel. Thus, the flicker problem under a flicker test pattern caused by the common voltage shift may be too insignificant to be noticed by the human eye.

However, when all pixels are enabled and display video signals having the same gray level, another kind of brightness difference problem occurs between pixels in odd and even rows.

Take the pixels A and B shown in FIG. 11 for example. FIG. 13 is a waveform diagram showing the waveforms for video data applied to the pixels A and B. The scanning signals V_{G1} and V_{G2} in the form of square waves are sequentially applied to the pixels in the first and second rows in every frame period. The ideal waveform V_{D1}′ for video data applied to the pixels A and B should be square waves, too. Because of data distortion caused by impedance of data lines in the liquid crystal panel through which video data signals travel, the real waveform for video data applied to the pixels A and B is much like V_{D1} as shown in FIG. 13.

In the (n−1)^{th} frame, the ideal waveform V_{D1}′ of the pixels A and B should be positive. However, the real waveform V_{D1} is distorted such that the pixel A is not charged as sufficiently as the pixel B, and the brightness of the pixel A is less than that of the pixel B. For the same reason, the pixel A is not charged as sufficiently as the pixel B in the n^{th} frame and in the (n+1)^{th} frame. That is, the brightness of the pixel A is always less than that of the pixel B. Similarly, the brightness of the two pixels in the other pixel pairs like the pixels A and B are always different from each other when a same gray level is applied.

Thus, it is desired to overcome the problem of the brightness difference between odd and even lines for the conventional 2-line inversion driving method, so that better display quality for liquid crystal displays can be achieved.

### SUMMARY

One embodiment of the invention provides a method for driving a liquid crystal display. The method comprises the steps of: (a) applying video signals with a first polarity pattern to the matrix of pixels during a first frame period, wherein each row or each column of the pixels under the first polarity pattern within a 2K-by-2K square sub-matrix includes a same number of pixels with positive polarity and negative polarity, the polarity sequences of each two rows or each two columns within the 2K-by-2K square sub-matrix of the first polarity pattern are different from each other, and K is not less than 2; (b) re-defining the first polarity pattern by a second polarity pattern, which is defined by sequentially shifting the polarity sequences of each row or column to an adjacent row or column within the 2K-by-2K square sub-matrix of the first polarity pattern, and correspondingly either shifting the polarity sequence of the last row or column to the first row or column within the 2K-by-2K square sub-matrix of the first polarity pattern, or shifting the polarity sequence of the first row or column to the last row or column within the 2K-by-2K square sub-matrix of the first polarity pattern; (c) applying video signals with the re-defined first polarity pattern to the matrix of pixels during a second frame period; and (d) repeating steps (b) and (c).

In another embodiment of the present invention, the second polarity pattern can be defined by sequentially shifting the polarity sequences of an (i−1)^{th} row to an i^{th} row within the 2K-by-2K square sub-matrix of the first polarity pattern and shifting the polarity of the pixels of the 2K^{th} row to the first row within the 2K-by-2K square sub-matrix of the first polarity pattern, or by sequentially shifting the polarity sequences of an (i+1)^{th} row to an i^{th} row and shifting the polarity sequences of the first row to the 2K^{th} row within the 2K-by-2K square sub-matrix of the first polarity pattern.

Moreover, the 2K-by-2K square sub-matrix is a 4-by-4 square sub-matrix, which has the polarity sequences of each row or each column thereof selected from the group consisting of: “+−−+”, “−++−”, “+−+−”, “−+−+”, ”++−−”, and “−−++”.

A detailed description of various embodiments is given below with reference to the accompanying drawings.

### BRIEF DESCRIPTION OF THE DRAWINGS

FIG. 1 is an abbreviated circuit diagram of a liquid crystal display, wherein the liquid crystal display can utilize a driving method in accordance with any of various embodiments of the present invention, and the liquid crystal display includes a liquid crystal panel having a matrix of pixels, a plurality of gate lines G₁˜G_{L}, and a plurality of data lines D₁˜D_{M}.

FIG. 2 illustrates a series of polarity patterns of video signals applied to a 4-by-4 square sub-matrix of the pixels of the liquid crystal panel of FIG. 1 during four continuous frames according to a driving method of a first embodiment of the present invention.

FIG. 3 is a waveform diagram showing waveforms of signals in gate lines G1 and G2, and ideal and real waveforms of signals in the data line D1, of the liquid crystal panel of FIG. 1 during the four continuous frames according to the driving method of the first embodiment.

FIG. 4 illustrates a series of polarity patterns with circles, in order to show characteristics of an image flicker test applied to the liquid crystal display of FIG. 1 using the driving method of the first embodiment.

FIG. 5 illustrates a series of polarity patterns of video signals applied to a 4-by-4 square sub-matrix of the pixels of the liquid crystal panel of FIG. 1 during four continuous frames according to a driving method of a second embodiment of the present invention.

FIG. 6 illustrates a series of polarity patterns of video signals applied to a 4-by-4 square sub-matrix of the pixels of the liquid crystal panel of FIG. 1 during four continuous frames according to a driving method of a third embodiment of the present invention.

FIG. 7 illustrates a series of polarity patterns of video signals applied to a 4-by-4 square sub-matrix of the pixels of the liquid crystal panel of FIG. 1 during four continuous frames according to a driving method of a fourth embodiment of the present invention.

FIG. 8 illustrates a series of polarity patterns of video signals applied to a 4-by-4 square sub-matrix of pixels of a liquid crystal panel of a liquid crystal display during three continuous frames using a conventional dot inversion driving method.

FIG. 9 is a schematic diagram of a sub-matrix of pixels of the liquid crystal panel relating to FIG. 8, showing a conventional flicker testing pattern when the conventional dot inversion driving method is used, wherein the pixels with oblique lines are disabled, and the pixels marked “R”, “G”, and “B” are enabled.

FIG. 10 illustrates a series of polarity patterns with circles, in order to show characteristics of an image flicker test applied to the liquid crystal display relating to FIG. 8 using the conventional dot inversion driving method.

FIG. 11 illustrates a series of polarity patterns of video signals applied to a 4-by-4 square sub-matrix of pixels of a liquid crystal panel of a liquid crystal display during three continuous frames using a conventional 2-line inversion driving method, the illustration including pixels A and B in first and second rows of the sub-matrix.

FIG. 12 illustrates a series of polarity patterns with circles, in order to show characteristics of an image flicker test applied to the liquid crystal display relating to FIG. 11 using the conventional 2-line inversion driving method.

FIG. 13 is a waveform diagram showing waveforms for video data applied to the two adjacent pixels A and B of the sub-matrix of the liquid crystal display relating to FIG. 11, and ideal and real waveforms for the two pixels, during the three continuous frames using the conventional 2-line inversion driving method.

### DETAILED DESCRIPTION

FIG. 1 is an abbreviated circuit diagram of a liquid crystal display that can utilize the driving method of the present invention. The liquid crystal display 2 includes a liquid crystal panel 20, a timing controller 21, a scanning circuit 22, a driving circuit 23, and a common voltage generating circuit 24. The liquid crystal panel has a plurality of scan lines G1˜G_{L} (L>1) connected to the scanning circuit 22, a plurality of data lines D1˜D_{M} (M>1) connected to the driving circuit 23, and a plurality of pixels 205 cooperatively defined by the crossing scan lines G1˜G_{L} and data lines D1˜D_{M}. Each pixel 205 includes a thin film transistor (TFT) 201 disposed near a respective intersection of the scan lines G1˜G_{L} and data lines D1˜D_{M}, a pixel electrode 202, a common electrode 203, and liquid crystal molecules interposed between the pixel electrode 202 and the common electrode 203. A gate terminal ‘g’ of each TFT 201 is connected to a corresponding one of the scan lines G1˜G_{L}, a source terminal ‘s’ of the TFT 201 is connected to a corresponding one of the data lines D₁˜D_{M}, and a drain terminal ‘d’ of the TFT 201 is connected to a corresponding one of the pixel electrodes 202. The common electrode 203 is connected to the common voltage generating circuit 24, which provides a common voltage for all the pixels 205.

In order to simplify the following explanation, the following definitions are provided. When the pixel electrode 202 in a pixel 205 has a data voltage applied thereto, and the data voltage is higher than the common voltage of the common electrode 203, the pixel 205 is defined as having positive polarity. When the pixel electrode 202 in the pixel 205 has a data voltage applied thereto, and the data voltage is lower than the common voltage of the common electrode 203, the pixel 205 is defined as having negative polarity. Furthermore, when the absolute value of the applied voltages of the respective pixel electrodes 202 of the pixels 205 are the same, only differing in positive or negative polarity, the pixels 205 are assumed to have the same gray level.

In a first embodiment of an inversion driving method of the present invention, the first step is dividing the matrix of pixels into several blocks of 2K-by-2K square sub-matrices. Each row or each column of the pixels under a predetermined first polarity pattern within a 2K-by-2K square sub-matrix includes a same number of pixels with positive polarity and negative polarity. The polarity sequences of each two rows or each two columns within the 2K-by-2K square sub-matrix of the first polarity pattern are different from each other. K is not less than 2 and is not larger than the smaller one of L/2 and M/2. The following description takes a 4-by-4 square sub-matrix of pixels as an example.

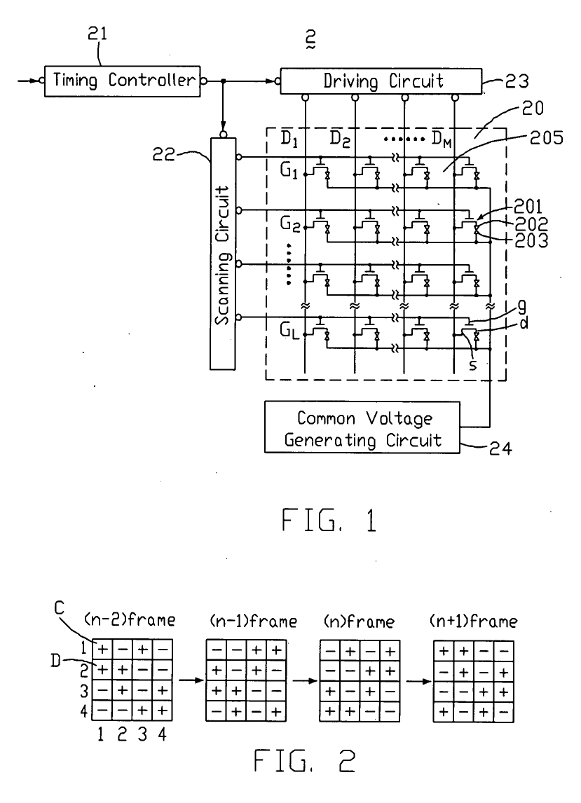

FIG. 2 illustrates a series of polarity patterns of video signals applied to a 4-by-4 square sub-matrix of the pixels 205 of the liquid crystal panel 20 during four continuous frame periods according to the driving method of first embodiment of the present invention. The polarity sequences of each row or each column of the 4-by-4 square sub-matrix are selected from the group of: “+−−+”, “−++−”, “+−+−”, “−+−+”, “++−−”, and “−−++”.

In FIG. 2, the polarity sequence of the second row of pixels in the (n−1)^{th} frame is the same as that of the first row of pixels in the (n−2)^{th} frame. The polarity sequence of the third row of pixels in the (n−1)^{th} frame is the same as that of the second row of pixels in the (n−2)^{th} frame. The polarity sequence of the fourth row of pixels in the (n−1)^{th} frame is the same as that of the third row of pixels in the (n−2)^{th} frame. The polarity sequence of the first row of pixels in the (n−1)^{th} frame is the same as that of the fourth row of pixels in the (n−2)^{th} frame. Thus, the polarity pattern of the (n−1)^{th} frame can be defined from that of the (n−2)^{th} frame.

In other words, the polarity pattern of a later frame period can be defined by sequentially shifting the polarity sequence of each row to a next adjacent row within the 4-by-4 square sub-matrix of the polarity pattern of a former frame period. In the case of the polarity sequence of the last row, this is shifted to the first row.

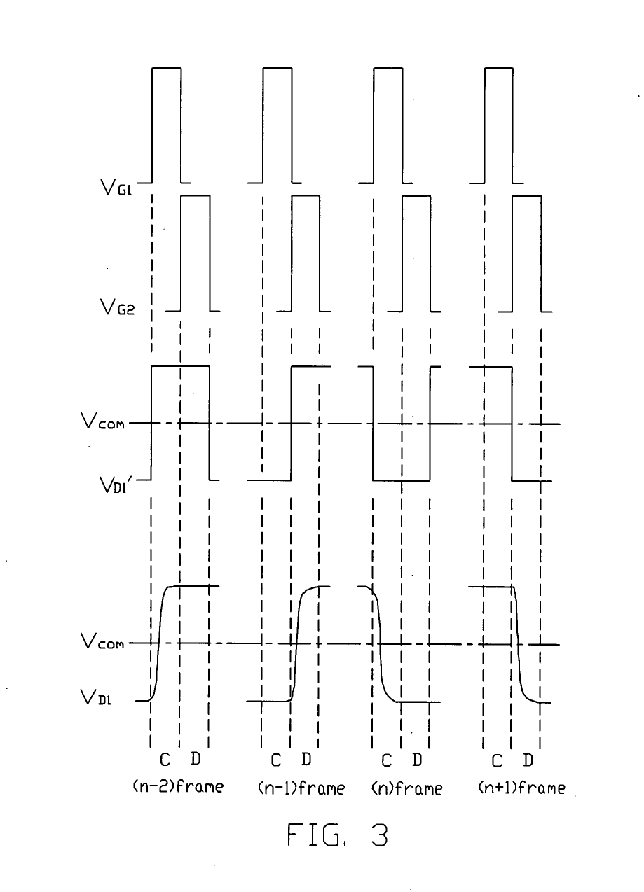

Take the pixels C and D shown in FIG. 2 for example. FIG. 3 is a waveform diagram showing waveforms applied to the pixels C and D. The scanning signals V_{G1} and V_{G2} in the form of square wave are sequentially applied to the pixels in the first and second rows in every frame period. The ideal waveform V_{D1}′ for video data applied to the pixels C and D should be square waves, too. Because of data distortion caused by impedance of the corresponding data lines, the real waveform for video data applied to the pixels C and D is much like V_{D1} as shown in FIG. 3.

The pixels displaying the same gray level but having opposite polarities may have different charging conditions because the common voltage of the liquid crystal panel may shift slightly when the polarity of each pixel is changed. Simultaneously, flickers occur when the polarities of all the enabled pixels displaying a same gray level are inverted at the same time.

In the (n−2)^{th} frame, the applied data voltage V_{D1} for the pixel C is smaller than the predetermined ideal voltage V_{D1}′, and the applied data voltage V_{D1} for the pixel D is about the same as the predetermined ideal voltage V_{D1}′. Therefore the charging condition of the pixel D is more sufficient than that of the pixel C, such that the brightness of the pixel C is lower than the brightness of the pixel D.

In the (n−1)^{th} frame, the applied data voltage V_{D1} for the pixel C is about the same as the predetermined ideal voltage V_{D1}′, because a former pixel adjacent to the pixel C has positive polarity. In contrast, the absolute value of the applied data voltage V_{D1} for the pixel D is lower than the absolute value of the predetermined ideal voltage V_{D1}′. Therefore the charging condition of the pixel C is more sufficient than that of the pixel D, such that the brightness of the pixel C is higher than the brightness of the pixel D.

The operation of the driving method in the n^{th} and the (n+1)^{th} frames is similar to the operation in the (n−2)^{th} and the (n−1)^{th} frames. The brightness of the pixel C is lower than the brightness of the pixel D in the n^{th} frame, and the brightness of the pixel C is higher than the brightness of the pixel D in the (n+1)^{th} frame. Also, the brightness of other pixels in the odd and even rows in different frame periods follows the same pattern as the brightness of the exemplary pixels C and D. Thus, the brightness of odd and even frame periods of each of the pixels can be mutually compensated. The problem of the brightness difference between odd and even lines in the conventional 2-line inversion driving method is solved or at least substantially circumvented.

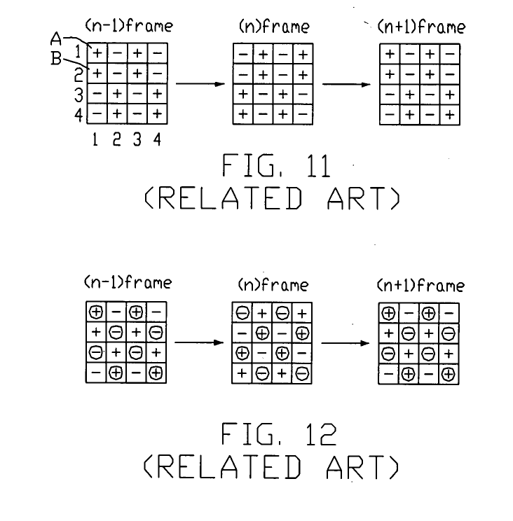

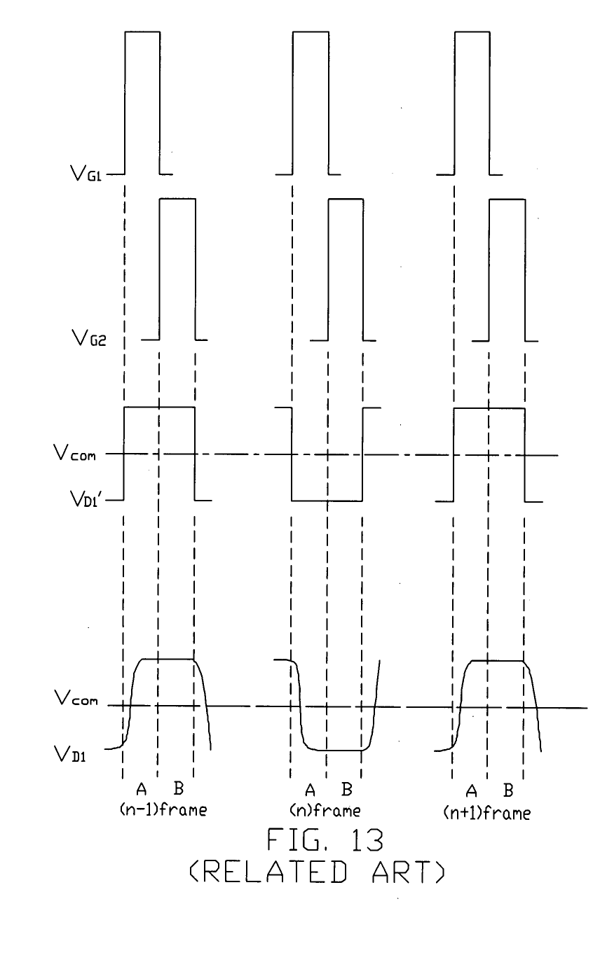

Referring to FIG. 4, when a conventional flicker test pattern (such as that shown in FIG. 9) is applied to the liquid crystal panel using the above-described block inversion method in accordance with the first embodiment of the present invention, only the pixels marked with circles are enabled. Each enabled pixel has positive polarity during one frame period, and complementary negative polarity during either the previous frame period or the next frame period. During any one frame period, half of the enabled pixels have positive polarity, and half of the enabled pixels have negative polarity. This can balance the brightness differences of each enabled pixel. Thus, the flicker problem under a flicker test pattern caused by the common voltage shift may be too insignificant to be noticed by the human eye.

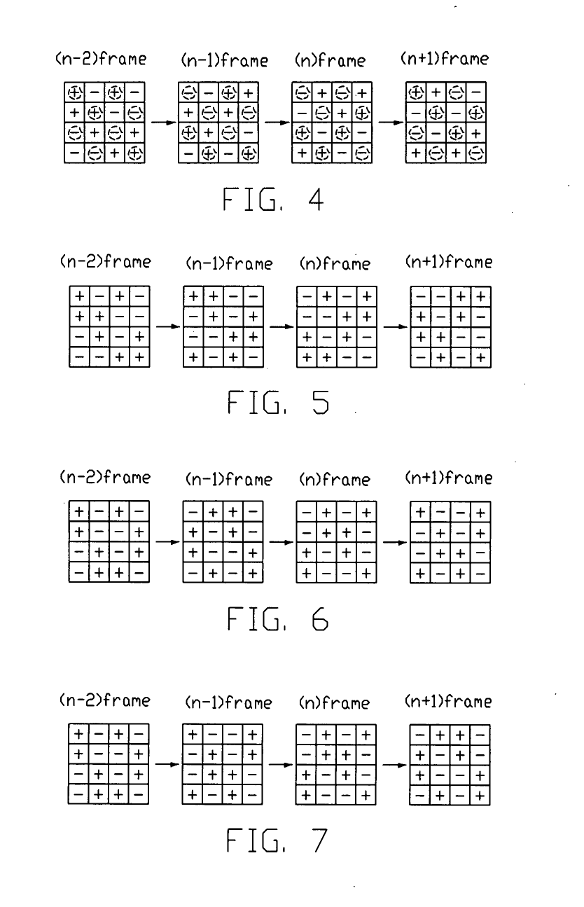

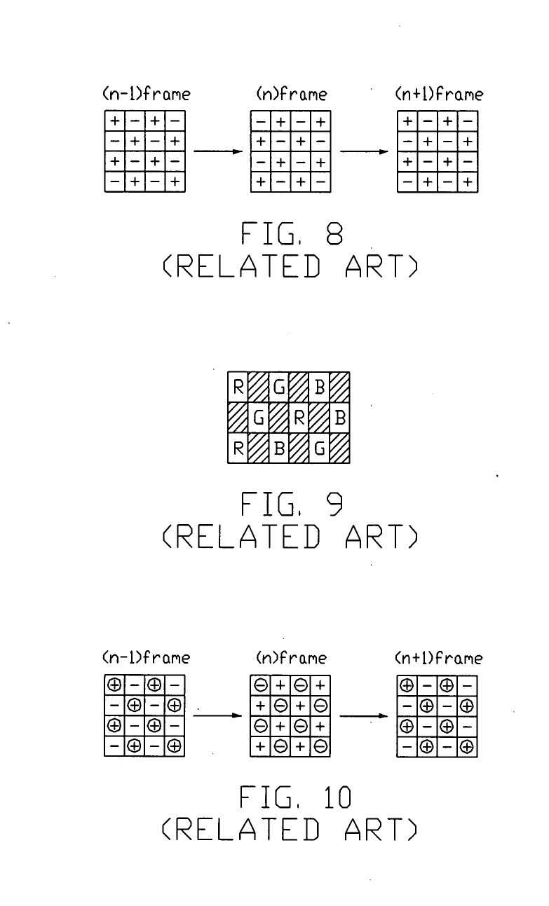

Furthermore, three other embodiments of the driving method of the present invention are described below. FIG. 5 illustrates a series of polarity patterns of video signals applied to a 4-by-4 square sub-matrix of the pixels 205 of the liquid crystal panel 20 during four continuous frame periods according to a driving method of a second embodiment of the present invention. The second embodiment is similar in principle to the above-described first embodiment. The polarity patterns of the second embodiment are the same as the polarity patterns of the first embodiment, but the sequential shifting of the polarity sequence of each row differs. In the second embodiment, the polarity sequence of the first row of pixels in the (n−1)^{th} frame is the same as that of the second row of pixels in (n−2)^{th} frame, the polarity sequence of the second row of pixels in the (n−1)^{th} frame is the same as that of the third row of pixels in (n−2)^{th} frame, the polarity sequence of the third row of pixels in the (n−1)^{th} frame is the same as that of the fourth row of pixels in (n−2)^{th} frame, and the polarity sequence of the fourth row of pixels in the (n−1)^{th} frame is the same as that of the first row of pixels in the (n−2)^{th} frame. Thus, the polarity pattern of the (n−1)^{th} frame can be defined from that of the (n−2)^{th} frame.

In the other words, the polarity pattern of a later frame period can be defined by sequentially shifting the polarity sequence of each row to a former adjacent row within the 4-by-4 square sub-matrix of the polarity pattern of a former frame period. In the case of the polarity sequence of the first row, this is shifted to the last row.

FIG. 6 illustrates a series of polarity patterns of video signals applied to a 4-by-4 square sub-matrix of the pixels 205 of the liquid crystal panel 20 during four continuous frame periods according to a driving method of a third embodiment of the present invention. The third embodiment is similar in principle to the above-described first and second embodiments. The sequential shifting of the polarity sequence of each row is the same as the sequential shifting of the first embodiment, but the polarity patterns of the third embodiment are different from the polarity patterns of the first and second embodiments. That is, in the third embodiment, the polarity pattern of a later frame period can be defined by sequentially shifting the polarity sequence of each row to a next adjacent row within the 4-by-4 square sub-matrix of the polarity pattern of a former frame period. In the case of the polarity sequence of the last row, this is shifted to the first row.

FIG. 7 illustrates a series of polarity patterns of video signals applied to a 4-by-4 square sub-matrix of the pixels 205 of the liquid crystal panel 20 during four continuous frame periods according to a driving method of a fourth embodiment of the present invention. The third embodiment is similar in principle to the above-described second and third embodiments. The polarity patterns of the fourth embodiment are the same as the polarity patterns of the third embodiment, and the sequential shifting of the polarity sequence of each row is the same as the sequential shifting of the second embodiment. That is, in the fourth embodiment, the polarity pattern of a later frame period can be defined by sequentially shifting the polarity sequence of each row to a former adjacent row within the 4-by-4 square sub-matrix of the polarity pattern of a former frame period. In the case of the polarity sequence of the first row, this is shifted to the last row.

While the above description has been by way of examples and in terms of preferred embodiments, it is to be understood that the invention is not limited thereto. To the contrary, the above description is intended to cover various modifications and similar arrangements (as would be apparent to those skilled in the art). Therefore, the scope of the appended claims should be accorded the broadest interpretation so as to encompass all such modifications and similar arrangements.

We claim:

1. A method for driving a liquid crystal display with a matrix of pixels, the method comprising:
(a) applying video signals with a first polarity pattern to the matrix of pixels during a first frame period, wherein each row or each column of the pixels under the first polarity pattern within a 2K-by-2K square sub-matrix of the matrix includes a same number of pixels with positive polarity and negative polarity, the polarity sequences of each two rows or each two columns within the 2K-by-2K square sub-matrix of the first polarity pattern are different from each other, and K is not less than 2;
(b) re-defining the first polarity pattern by a second polarity pattern, which is defined by sequentially shifting the polarity sequences of each row or column to an adjacent row or column within the 2K-by-2K square sub-matrix of the first polarity pattern, and correspondingly either shifting the polarity sequence of the last row or column to the first row or column within the 2K-by-2K square sub-matrix of the first polarity pattern, or shifting the polarity sequence of the first row or column to the last row or column within the 2K-by-2K square sub-matrix of the first polarity pattern; and
(c) applying video signals with the re-defined first polarity pattern to the matrix of pixels during a second frame period.

2. The method as claimed in claim 1, further comprising: repeating the procedure described in (b), and repeating the procedure described in (c).

3. The method as claimed in claim 1, wherein the second polarity pattern is defined by sequentially shifting the polarity sequence of an (i−1)^{th} row or column to an i^{th} row or column within the 2K-by-2K square sub-matrix of the first polarity pattern, and shifting the polarity sequence of the 2K^{th} row or column to the first row or column within the 2K-by-2K square sub-matrix of the first polarity pattern.

4. The method as claimed in claim 1, wherein the second polarity pattern is defined by sequentially shifting the polarity sequence of an (i+1)^{th} row or column to an i^{th} row or column within the 2K-by-2K square sub-matrix of the first polarity pattern, and shifting the polarity sequence of the pixels of the first row or column to the 2K^{th} row or column within the 2K-by-2K square sub-matrix of the first polarity pattern.

5. The method as claimed in claim 1, wherein the 2K-by-2K square sub-matrix is a 4-by-4 square sub-matrix.

6. The method as claimed in claim 5, wherein the polarity sequences of each row or each column of the 4-by-4 square sub-matrix are selected from the group consisting of: “+−−+”, “−++−”, “+−+−”, “−+−+”, “++−−”, and “−−++”.

7. A method for driving a liquid crystal display with a matrix of pixels, the method comprising:
(a) applying video signals with a first polarity pattern to the matrix of pixels during a first frame period, wherein each row or each column of the pixels under the first polarity pattern within a 2K-by-2K square sub-matrix includes a same number of pixels with positive polarity and negative polarity, the polarity sequences of each two rows or each two columns within the 2K-by-2K square sub-matrix of the first polarity pattern are different from each other, and K is not less than 2;
(b) re-defining the first polarity pattern by a second polarity pattern, which is defined by sequentially shifting the polarity sequences of an (i+1)^{th} row to an i^{th} row and shifting the polarity sequences of the first row to the 2K^{th} row within the 2K-by-2K square sub-matrix of the first polarity pattern; and
(c) applying video signals with the re-defined first polarity pattern to the matrix of pixels during a second frame period; and (d) repeating steps (b) and (c).

8. The method as claimed in claim 7, wherein the 2K-by-2K square sub-matrix is a 4-by-4 square sub-matrix.

9. The method as claimed in claim 8, wherein the polarity sequences of the 4-by-4 square sub-matrix are selected from the group consisting of: “+−−+”, “−++−”, “+−+−”, “−+−+”, “++−−”, and “−−++”.
